(19) United States
(12) Patent Application Publication
(10) Pub. No.: US 2009/0258152 A1
(43) Pub. Date: Oct. 15, 2009

(54) Coating apparatus and coating method

(75) Inventor: Hidenori Miyamoto, Kanagawa (JP)

Correspondence Address: CARRIER BLACKMAN AND ASSOCIATES, 43440 WEST TEN MILE ROAD, EATON CENTER, NOVI, MI, 48375, US

(73) Assignee: Tokyo Ohka Kogyo Co., Ltd., Kawasaki-shi (JP)

(21) Appl. No.: 12/384,720

(22) Filed: Apr. 8, 2009

(30) Foreign Application Priority Data
Apr. 9, 2008 (JP) 2008-101800

(51) Int. Cl. B05D 1/02; B05C 5/00

(52) U.S. Cl. 427/427.3; 118/58

(57) ABSTRACT

A coating apparatus and a coating method that are suitable for manufacturing a MEMS or a substrate having a through electrode are provided. A nozzle 14 gradually moves in the X-axis direction while being moved back and forth in the vertical direction (Y-axis direction). When coating in the vertical direction is completed, the nozzle 14 gradually moves in the Y-axis direction while being moved back and forth in the lateral direction (X-axis direction). Thus, the nozzle 14 coats the surface of a substrate W while scanning the surface twice during a single coating, and uncoated areas can be eliminated by making the direction in the first scanning and the direction in the second scanning different from each other by 90°.

### BACKGROUND OF THE INVENTION

1. Field of the Invention

The present invention relates to a coating apparatus and a coating method used when forming a film on a substrate surface and the like.

2. Description of the Related Art

As a coating apparatus for forming a film on the surface of a substrate such as a semiconductor wafer, as disclosed in Japanese Patent Laid-Open No. 2006-055756, an apparatus is known in which a heater is provided on a stage on which a substrate is mounted, and the stage can be moved along the X, Y, and Z axes. In particular, according to this coating apparatus, by causing an air current that carries resist particles that are sprayed onto an uneven surface of a substrate to flow at a high speed, and adopting a configuration such that the Reynolds number Re at the time of arrival at a workpiece exceeds 4,300, a film of a uniform thickness is formed on the uneven surface.

### SUMMARY OF THE INVENTION

As the size of a substrate increases, the size of a stage on which the substrate is to be mounted also increases. When a heater or the like is embedded in a stage to give the stage a function of a hot plate, the weight of the stage increases. There is a limit to the extent to which a stage that has increased in size and in weight can be moved along the X, Y, and Z axes as described in Japanese Patent Laid-Open No. 2006-055756.

To solve the above problem, the present invention provides a coating apparatus having a stage on which a substrate is mounted, and a nozzle that supplies a coating liquid to the substrate surface, wherein the stage comprises heat treatment means such as a hot plate that heats the substrate, and the nozzle can be moved along a plane that is parallel with the stage.

A hot plate or the like may be mentioned as an example of the heat treatment means. Preferably, the size of the hot plate is smaller than the substrate to prevent a coating liquid from adhering to the hot plate surface during coating. Further, it is preferable to provide the nozzle with a scattering prevention cover to prevent a coating liquid that is supplied from the nozzle from scattering upon receiving an air flow when the nozzle moves.

Furthermore, according to the coating method of the present invention, a configuration is adopted such that the nozzle applies coats the surface of a substrate while scanning the surface twice during a single coating, and the direction in the first scanning and the direction in the second scanning differ from each other by 90°.

According to the present invention, by fixing a stage comprising heat treatment means, the overall apparatus becomes compact. Further, by allowing a nozzle to move along a plane parallel with the stage, namely, by enabling movement thereof in the X-axis and Y-axis directions, it is difficult for areas that are left uncoated with the coating liquid to arise.

In particular, the coating apparatus and coating method according to the present invention are useful when utilizing a photolithography technique to manufacture a semiconductor that requires ultrafine fabrication such as a MEMS (Micro Electro Mechanical System) or a thick film circuit board.

More specifically, when manufacturing a MEMS utilizing a photolithography technique, conventionally a photoresist film is formed on a substrate surface. In particular, a MEMS also includes a micrometer size sensor, an actuator and the like, and unlike a semiconductor circuit, a concavo-convex portion with a depth of approximately 100 to 1000 μm is formed on the substrate surface. In the case of performing micro-processing such as etching on this kind of concavo-convex portion, in particular when it is desired to perform micro-processing on a concave portion, if the thickness of the photoresist film formed in the concave portion is an extremely thick thickness of 100 to 1000 μm, the processing time required for a development process becomes remarkably long, and therefore the throughput decreases. Therefore, to prevent this problem from occurring, it is desirable that a film formed in a concave portion is formed with approximately the same thickness as a film on a convex portion. It is also necessary to protect a lateral wall part of a concave portion when performing the etching process. Because of the above circumstances, it is necessary to form a resist film of a uniform thickness on the surface of the concavo-convex portion.

As prior art technology that forms a resist film of a uniform thickness on the surface of a concavo-convex portion, Japanese Patent Laid-Open No. 2003-236799 discloses technology in which, after forming a film by spray coating on a sample having a three-dimensional structure, the diffusive movement of a resist material on the sample is promoted by placing the sample under an atmosphere including a large amount of solvent vapor for a certain time to thereby correct minute pores included in the resist film and localized unevenness in the film thickness of the sample, and thereby achieve a uniform film thickness.

However, according to this method, pinholes are liable to occur in the resist that has been coated on the bottom of concave portions. When lithography is performed while pinholes remain, defects will occur in the pattern that is formed, and thus cause a product fault. Therefore, although the probability of pinholes occurring in the film is reduced by increasing the film thickness and the amount of resist when spray coating, thickening the resist film necessitates the use of an overexposure condition that is a local change in the optimal exposure and development conditions, and results in a distortion in the pattern formation and a drop in the resolution.

Japanese Patent Laid-Open No. 2005-334754 discloses other prior art technology for forming a resist film of a uniform thickness on the surface of a concavo-convex portion. A coating film forming apparatus disclosed in the aforementioned Japanese Patent Laid-Open No. 2005-334754 has a spray nozzle that sprays a coating liquid in the shape of particles; a particle shape detecting portion that detects the shape of particles of the coating liquid that are sprayed from the spray nozzle; and nozzle height adjusting means that adjusts the height from the surface of the coating object to the spray nozzle; wherein: the spray nozzle includes spray pressure adjusting means that adjusts the pressure of a gas for spraying the coating liquid, and spray quantity adjusting means that adjusts a spray quantity of the coating liquid; a work stage on which the coating object is mounted includes temperature adjusting means that heats the coating object, a film condition detection portion that detects the condition of a coating film formed on the coating object surface, and an object temperature detecting portion that detects a temperature of the coating object; and by controlling one member or a combination of members of the group consisting of the nozzle height adjusting means, the spray pressure adjusting means, the spray quantity adjusting means, and the temperature adjusting means based on information detected by the particle shape detecting portion, the film condition detection portion, and the object temperature detecting portion, a film of a uniform thickness is formed.

However, because there are many control factors such as the spray pressure adjusting means, spray quantity adjusting means, temperature adjusting means, film condition detection portion, and object temperature detecting portion, the control of the above apparatus is complicated, and it is also not possible to form a film of a uniform thickness on an uneven surface using only these factors.

According to the present invention, a film (resist film) of a uniform thickness can be formed on the surface of a substrate having minute concavities and convexities, more specifically, a film of a uniform thickness can be formed in a continuous manner on the bottom surface of a concave portion, a sidewall of a concave portion, and the top surface of a convex portion.

### BRIEF DESCRIPTION OF THE DRAWINGS

FIG. 1 is a view that illustrates a schematic configuration of a film forming apparatus that incorporates the coating apparatus according to the present invention;

FIG. 2 is a plan view of the coating apparatus according to the present invention;

FIG. 3(a) is a sectional view of a coating nozzle, and FIG. 3(b) is a view from below the coating nozzle;

FIG. 4 is a sectional view of a nozzle cleaning portion;

FIG. 5 is a sectional view of an air discharge portion;

FIGS. 6(a) to 6(c) are views that illustrate a first coating step of a film formation method using the coating apparatus according to the present invention;

FIGS. 7(a) and 7(b) are views that illustrate a second coating step of the film formation method using the coating apparatus according to the present invention; and

FIGS. 8(a) and 8(b) are views that illustrate an example of a spray coating method.

### DETAILED DESCRIPTION OF THE PREFERRED EMBODIMENT

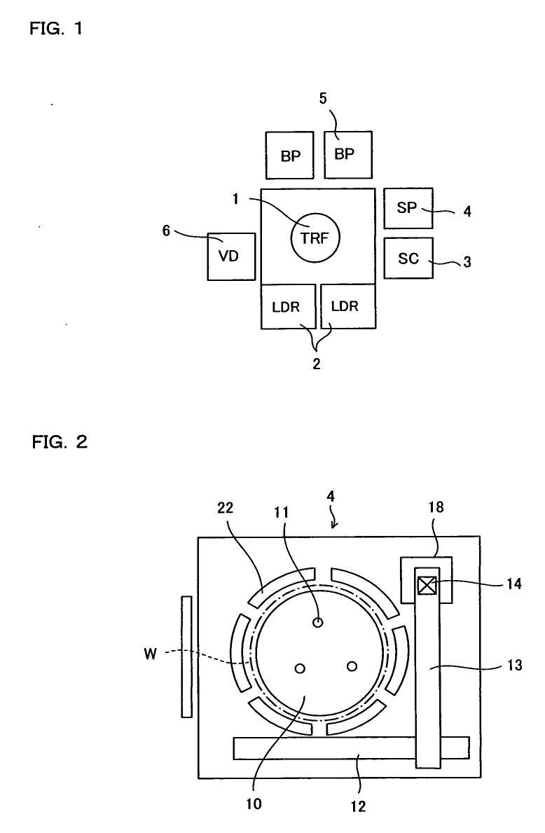

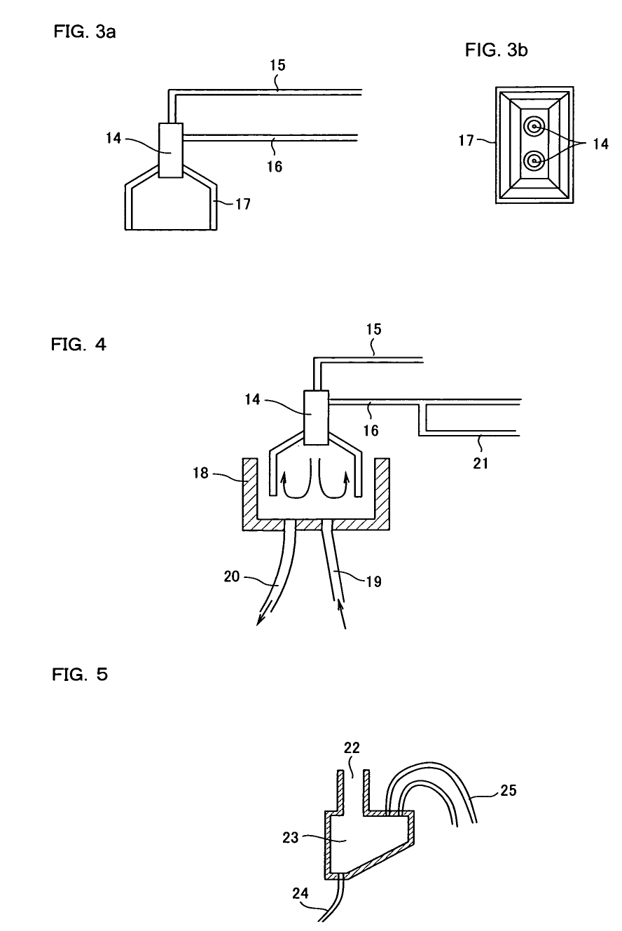

The coating apparatus according to the present invention is described hereunder with reference to the attached drawings. FIG. 1 is a view that illustrates a schematic configuration of a film forming apparatus that incorporates the coating apparatus according to the present invention. FIG. 2 is a plan view of the coating apparatus according to the present invention. FIG. 3(a) is a sectional view of a coating nozzle, and FIG. 3(b) is a view from below the coating nozzle. FIG. 4 is a sectional view of a nozzle cleaning portion.

In the film forming apparatus, loaders 2, a standard cup 3, a coating apparatus 4, a heating and cooling apparatus 5, and a vacuum degassing apparatus 6 are arranged around a robot 1 disposed at the center of the film forming apparatus.

The coating apparatus 4 includes a hot plate 10 in the center thereof. Lift pin through-holes 11 are formed in the hot plate 10, and the hot plate 10 is configured to also serve as a mounting stage for a substrate W. The external diameter dimensions of the hot plate 10 are made smaller than the external diameter dimensions of the substrate W so that a coating liquid is not applied to the surface of the hot plate 10, thereby enhancing the ease of maintenance.

A guide rail 12 is provided in the X-axis direction at a side of the hot plate 10. A guide rail 13 slidably engages with the guide rail 12 in the Y-axis direction. A nozzle 14 that sprays a coating liquid is attached to the guide rail 13 in the Y-axis direction, and the nozzle 14 is movable along the guide rail 13. In this connection, since the guide rail 13 is movable in the X-axis direction along the guide rail 12, the nozzle 14 can be moved in the X and Y directions, namely, along a plane parallel with the top surface of the hot plate 10 (stage).

The coating apparatus 4 is provided with a pair of the nozzles 14. A resist (coating liquid) supply pipe 15 and a nitrogen gas supply pipe 16 are connected to each nozzle 14. The pair of nozzles 14 is housed inside a cone-shaped cover 17 to prevent scattering.

A cleaning device 18 having a cap shape is disposed at a standby position of the nozzles 14. A dry air supply pipe 19 and a drain discharge pipe 20 are connected to the bottom of the cleaning device 18.

In order to clean the nozzles 14, a cleaning fluid supply pipe 21 is connected to the nitrogen gas supply pipe 16, a cleaning fluid is fed to the nozzles 14 using nitrogen gas, the cleaning fluid is emitted from the nozzles 14 to clean the inside surface of the cover 17 and, simultaneously, air from the dry air supply pipe 19 is used to dry the inside surface of the cover 17.

An air outlet 22 is formed in the outer side of the hot plate 10. The air outlet 22 connects with a discharge air chamber 23 provided on the underside thereof. The bottom surface of the discharge air chamber 23 is formed in an inclined plane, and a drain discharge pipe 24 is connected to the lowest position thereof. An air release pipe 25 is connected to the top surface of the discharge air chamber 23.

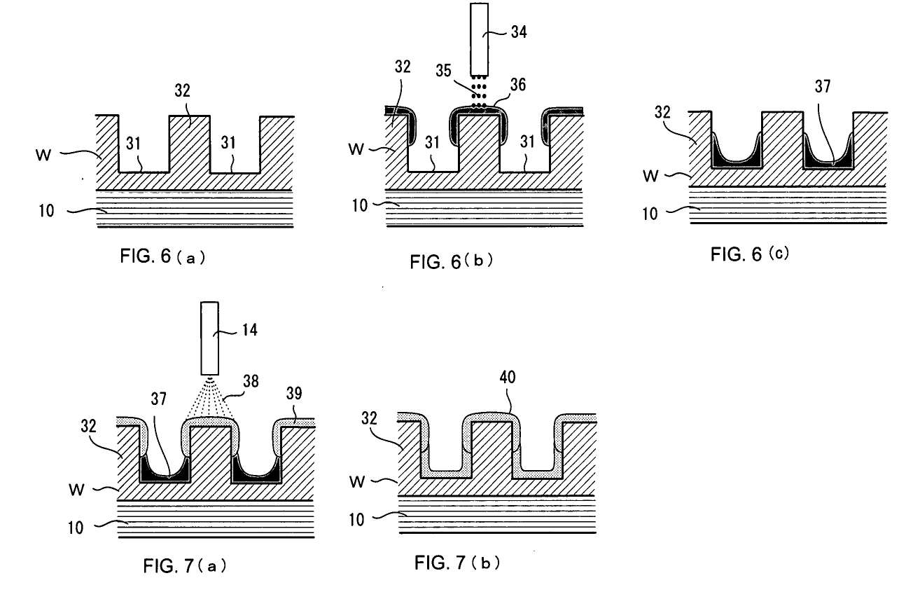

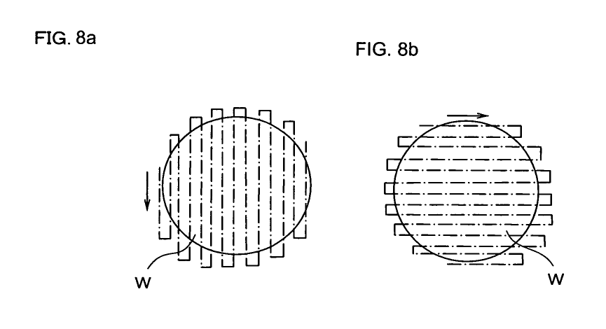

A method of forming a film of a uniform thickness on a substrate having minute concavities and convexities on the surface using the above described apparatus will now be described referring to FIGS. 6 to 8. FIGS. 6(a) and 6(b) are views that illustrate a first coating step of a film formation method. FIGS. 7(a) and 7(b) are views that illustrate a second coating step of the film formation method. FIGS. 8(a) and 8(b) are views that illustrate an example of spray coating.

Concave portions 31 and convex portions 32 are formed in succession on the surface of the substrate W prior to coating. As shown in FIG. 6(a), in the first coating step the substrate W is placed on the hot plate 10. Subsequently, as shown in FIG. 6(b), a coating liquid 35 is supplied to the surface of the substrate W from a nozzle 34 of a spin coater, although in this case it is also possible to use the spray nozzle 14 of the coating apparatus 4. The coating liquid 35 is a photoresist coating liquid, and may be either positive or negative. In this case, because the concavo-convex portions have an extremely high aspect ratio it is difficult for the coating liquid that is supplied to reach the bottom of the concave portions 31 and, as shown in FIG. 6(b), nearly all of the coating liquid is used to form a film 36 in a region from a depth of at least the center of the convex portion 32 as far as the top surface. In this connection, the coating method is not limited to a spin coating method or a spray coating method, and any kind of coating method can be utilized for the first coating step, such as a slit coating method, as long as a coating film is formed on the substrate.

When a film has been formed in the first coating step as described above, the film 36 is heated by the hot plate 10 and reflows. The heating temperature is 20 to 100° C., and the heating time is 1 to 5 minutes. As a result of this heating treatment, as shown in FIG. 6(c), the film 36 drops downward such that a film 37 is formed from the bottom of the concave portion 31 to an intermediate depth position of the wall portion. By means of the film 37, a film of an approximately uniform thickness is formed from at least the bottom of the concave portion 31 to an intermediate depth position of the wall portion.

Next, a second coating step is performed. In the second coating step a coating liquid 38 is sprayed towards the surface of the substrate W using the spray nozzle 14 of the coating apparatus 4.

It should be noted that although the spraying method is arbitrary, for example, as shown in FIG. 8(a), the nozzle 14 moves gradually in the X-axis direction while being moved back and forth in the vertical direction (Y-axis direction). When the coating in the vertical direction is completed, the nozzle 14 moves gradually in the Y-axis direction while being moved back and forth in the lateral direction (X-axis direction). Thus, the nozzle 14 coats the surface of the substrate W while scanning the surface twice during a single coating, and uncoated areas can be eliminated by making the direction in the first scanning and the direction in the second scanning different from each other by 90°

It is difficult for the coating liquid 38 that is sprayed from the spray nozzle 14 to reach the bottom of the concave portion 31 and, as shown in FIG. 7(a), a film 39 is formed in a region from an intermediate depth position of the concave portion 31 to the top surface of the convex portion 32.

After the film 39 has been formed in the second coating step as described above, the film 39 is heated by the hot plate 10. The heating treatment conditions are, for example, 70 to 150° C. for 1 to 3 minutes. As shown in FIG. 7(b), by means of the film 39 and the film 37, a film 40 that has a uniform thickness is formed over the total surface of the concave portions 31 and the convex portions 32.

In this connection, since the film 39 is formed in the convex portions, in particular when it is not necessary to perform micro-processing in the convex portions, the coating liquid 38 is not restricted to a photosensitive material (a so-called photoresist coating liquid), and may be a material that is suitable for spray coating and that is insoluble or difficult to dissolve with respect to an alkali developer.

After forming a film of an approximately uniform thickness in this manner, for example, when it is desired to form holes for through electrodes in the concave portions 31 of the substrate W, one part of the film formed on the concave portion 31 is selectively exposed, and when the coating liquid is a positive resist fluid, next the film is removed at a place that has been exposed to light in a development process using an aqueous alkaline solution (for example, a 2.38 wt % tetramethylammonium hydroxide aqueous solution); and hence, by performing a known etching process using that as a mask, and subsequently removing the remaining film using a peeling agent or an ashing process, it is possible to obtain a substrate W in which holes are formed in the bottom of the concave portions 31.

Since a resist film to be formed in a concave portion can be formed with a thin thickness in this manner, the time taken for development processing can be significantly shortened. In this connection, although the first coating step was performed first according to this embodiment, the second coating step may be performed before the first coating step.

The film formation method according to the present invention can be utilized for manufacturing a MEMS utilizing photolithography technology or a substrate that has through electrodes and the like.

1. A coating apparatus comprising a stage on which a substrate is mounted, and a nozzle that supplies a coating liquid to a substrate surface, wherein the stage comprises heat treatment means that heats a substrate, and the nozzle is capable of moving along a plane that is parallel with the stage.

2. The coating apparatus according to claim 1, wherein dimensions of the heat treatment means are smaller than dimensions of a substrate, and a scattering prevention cover is provided on the nozzle.

3. A coating method that uses a coating apparatus according to claim 1, wherein the nozzle coats a surface of a substrate while scanning the surface twice in a single coating, and a first scanning in a direction and a second scanning in a direction are caused to differ by 90°.

4. A coating method that uses a coating apparatus according to claim 2, wherein the nozzle coats a surface of a substrate while scanning the surface twice in a single coating, and a first scanning in a direction and a second scanning in a direction are caused to differ by 90°.
